(19) United States
(12) Patent Application Publication
(10) Pub. No.: US 2024/0420155 A1
(43) Pub. Date: Dec. 19, 2024

(54) SYSTEMS AND METHODS FOR PROCESSING ROADSIDE ASSISTANCE QUERIES

(71) Applicant: Allstate Insurance Company, Northbrook, IL (US)

(72) Inventors: Anthony Banks, Matthews, NC (US); Todd Bucco, Lake Villa, IL (US); Brandon Tarvin, Upatoi, GA (US)

(21) Appl. No.: 18/209,137

(22) Filed: Jun. 13, 2023

(51) Int. Cl. G06Q 30/015; G06F 16/9035

(52) U.S. Cl. CPC G06Q 30/015; G06F 16/9035

(57) ABSTRACT

Implementations claimed and described herein provide systems and methods for responding to a query associated with a roadside assistance request. The systems and methods use a chatbot to identify a category of the query and generate a response. The response is sent to a user device for display.

### FIELD

Aspects of the presently disclosed technology relate generally to processing systems and methods. More specifically, aspects of this disclosure relate to systems and methods for processing queries associated with roadside assistance requests.

### BACKGROUND

A vehicle failure can happen unexpectedly and may be a difficult problem to solve for the driver of the vehicle. Before the proliferation of computers and computerized devices, an individual would likely directly interact with businesses to arrange for roadside assistance, such as towing services, flat tire assistance, fuel services, automobile repairs, oil changes, and scheduled maintenance appointments, etc., through various interfaces requiring some sort of physical interaction, such as face-to-face conversation, a phone conversation, and/or the like. Roadside assistance services, such as services offered by dealerships, and/or services offered by car clubs help arrange for the needed assistance. Often, users will communicate with the Roadside assistance services for status updates, to cancel the request, and/or to provide information to a roadside service provider responding to the request.

However, having enough live staff to answer phone calls from users without long wait times is expensive and requires a lot of training for staff. As such, communications to roadside assistance services by conventional systems do not effectively process roadside assistance requests due to long wait times and/or ineffective staff. It is with these observations in mind, among others, that various aspects of the present disclosure were conceived and developed.

### SUMMARY

Implementations described and claimed herein address the foregoing problems by providing systems and methods for using chatbots for processing queries related to roadside assistance requests. For instance, a computer implemented method can comprise: receiving a query in a text communication from a user device, the query associated with a previously submitted roadside assistance request; identifying a category of the query; generating a query response based on the category; and sending the query response to the user device to cause the user device to display the query response.

In some implementations, a system comprises a chatbot computing platform comprising one or more processors configured to: receive a query in a text communication from a user device, the query associated with a roadside assistance request; identify a category of the query; generate a response based on the category; and send the response to the user device to cause the user device to display the response.

In some instances, one or more tangible non-transitory computer-readable storage media store computer-executable instructions for performing a computer process on a computing system, the computer process comprising: receiving a query in a text communication from a user device, the query associated with a roadside assistance request; identifying a category of the query; generating a response based on the category; and sending the response to the user device to cause the user device to display the response.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system to process a query regarding a roadside assistance request.

FIG. 2 illustrates an example system to process a query regarding a roadside assistance request.

FIG. 3 illustrates an example system to process a query regarding a roadside assistance request.

FIG. 4 illustrates an example method to process a query regarding a roadside assistance request.

### DETAILED DESCRIPTION

Aspects of the present disclosure involve systems and methods to process a query regarding a roadside assistance using a chatbot to process communication received from a user. The systems and methods described herein use natural language processing to determine an intent of the user for roadside assistance services. The determined intent is used to submit a roadside assistance request. This results in a more user friendly interface without needing the use of a live agent. Additional advantages of the presently disclosed technology will become apparent from the detailed description below.

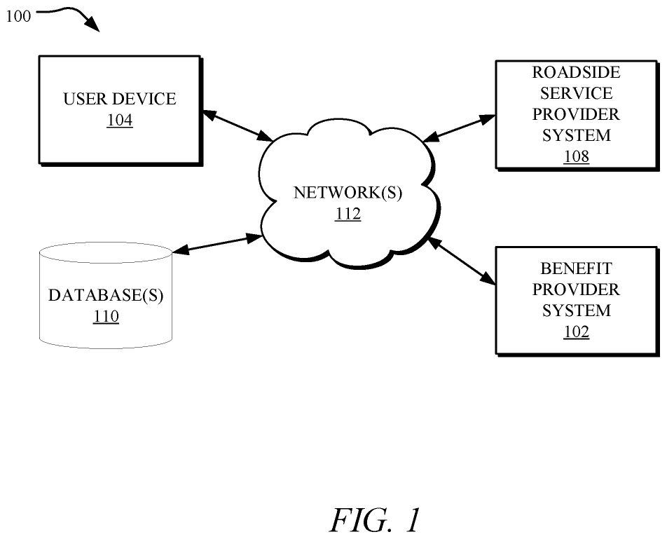

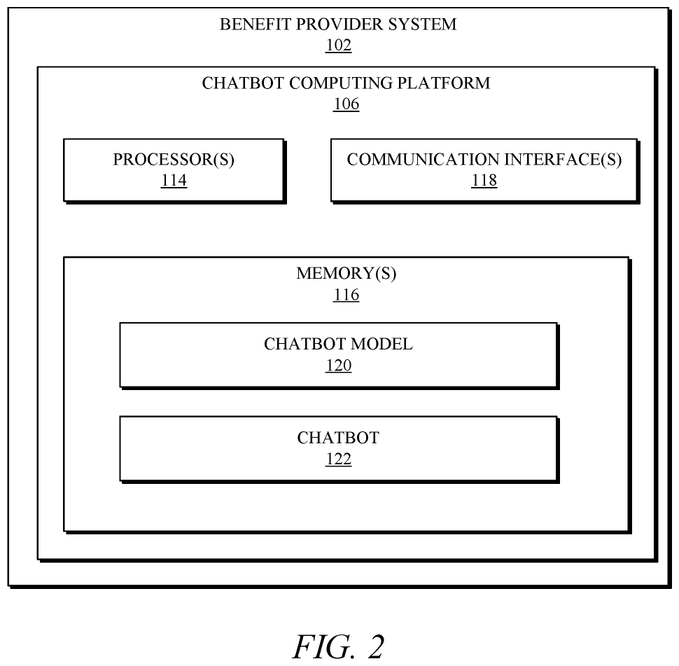

To begin a detailed description of an example system 100 to for processing query related to a roadside assistance request, reference is made to FIGS. 1-4. The system 100 can include a benefit provider system 102 configured to receive a query regarding a previously submitted roadside assistance request. The query is a text communication inputted by a user via a user device 104. The text communication can be made via a text message (e.g., Short Message Service (SMS), Multimedia Messaging Service (MMS), etc.) and/or an online chat interface. Upon receiving the query, the benefit provider system 102 processes the query using a chatbot computing platform 106 to generate a response to the query that is sent to the user device 104 for display. The system 100 may further include a roadside service provider system 108 and one or more databases 110. The benefit provider system 102, the roadside service provider system 108, and the one or more databases 110 are configured to interact with one another via a network(s) 112. As illustrated in greater detail below, any and/or all of benefit provider system 102, chatbot computing platform 106, user device 104, one or more databases 110 may, in some instances, be special-purpose computing devices configured to perform specific functions.

The benefit provider system 102 includes one or more telephone systems, one or more computing devices (e.g., servers, routers, user interface devices, internet telephony computing device, and the like) that store and/or retrieve data in one or more databases, provide user interfaces, phone system functionality, execute the chatbot computing platform 106, etc. by processing instructions. The benefit provider system 102 can be configured to monitor and store (e.g., with appropriate permissions) the text communication for further analysis. In an implementation, the benefit provider system 102 is configured to transmit the text communication to another computing device or database, such as the one or more databases 110. In an implementation, the benefit provider system 102 is associated with an organization or entity (e.g., an insurance company). In an implementation, the benefit provider system 102 can retrieve and send policy and/or benefit information that indicate what roadside assistance services are available to the user.

The user is able to submit a query via text communication to the benefit provider system 102 via one or more text interfaces using the user device 104. The user device 104 can be a computing device (e.g., smartphone, tablet, desktop computer, laptop computer, or other personal computing device) that may be used by an individual (e.g., a customer of an enterprise organization, such as an insurance provider, an employee of an enterprise organization, such as a customer service representative for an insurance provider, etc.). In some instances, the user device 104 may be used to display chatbot interfaces and/or other alerts/graphical user interfaces.

The chatbot computing platform 106 is configured to perform one or more of the functions described herein. For example, the chatbot computing platform 106 may include one or more computers (e.g., laptop computers, desktop computers, or servers). The chatbot computing platform 106 may include one or more processors 114, memory(s) 116, and communication interface(s) 118. A data bus may interconnect the one or more processors 114, memory(s) 116, and communication interface(s) 118. The communication interface(s) 118 may be a network interface configured to support communication between the chatbot computing platform 106 and the network(s) 112. The memory(s) 116 may include one or more program modules having instructions that when executed by the one or more processors 114 cause the chatbot computing platform 106 to perform one or more functions described herein and/or one or more databases that may store and/or otherwise maintain information which may be used by such program modules and/or the one or more processors 114. In some instances, the one or more program modules and/or databases may be stored by and/or maintained in different memory units of the chatbot computing platform 106 and/or by different computing devices that may form and/or otherwise make up the chatbot computing platform 106. For example, the memory(s) 116 may have, store, and/or include a chatbot model 120 and one or more chatbots 122. In an implementation, the chatbot model 120 is a machine learning model. The chatbot model 120 may have instructions that direct and/or cause the chatbot computing platform 106 to train, maintain, and deploy the one or more chatbots 122 using the chatbot model 120 to execute the techniques, as discussed in greater detail below. The one or more chatbots 122 may each correspond to a unique chatbot model 120, which may be trained as an expert on a particular topic (e.g., queries related to a submitted roadside assistance request).

In an implementation, the chatbot model 120 is trained to support dynamic and configurable bot conversations with a user with regard to queries related to roadside assistance requests. The chatbot model 120 may be built from historical conversation data stored, of example, at the one or more databases 110. In this implementation, the chatbot model 120 leverages historical conversational data relating to user queries relating to roadside assistance requests to identify a category that the query belongs to. For instance, the categories can include a status update of the roadside assistance request, cancelling the roadside assistance request, and information for a service provider.

The chatbot computing platform 106 may have instructions that direct and/or cause the chatbot computing platform 106 to receive a query relating to a roadside assistance request, identify a category of the query, process the query with the one or more chatbots 122, generate a response to the query, and send the query response to the user device 104 to cause the query response to be displayed by the user device 104.

The roadside service provider system 108 includes one or more telephone systems, one or more computing devices (e.g., servers, routers, user interface devices, internet telephony computing device, and the like) that store and/or retrieve data in one or more databases, provide user interfaces, phone system functionality, etc. by processing instructions. The roadside service provider system 108 can assign a service provider (e.g., tow truck) in response to the roadside assistance request. The assignment can be performed automatically by the one or more computing devices or by an agent. In an implementation, the roadside service provider system 108 can provide status updates regarding the roadside assistance request to the user via the chatbot computing platform 106 and the user device 104 in response to the query.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

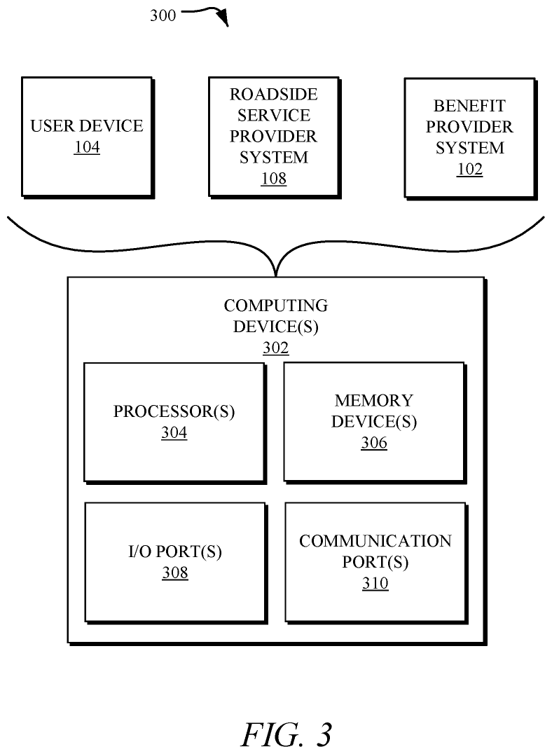

Turning to FIG. 3, a system 300 to process a request to provide roadside assistance can include one or more computing device(s) 302 for performing the techniques discussed herein. In one implementation, the one or more computing device(s) 302 include one or more servers of the user device 104, the roadside service provider system 108, and/or the benefit provider system 102 to generate and execute the chatbot computing platform 106 as a software application and/or a module or algorithmic component of software.

In some instances, the computing device(s) 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device(s) 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more hardware processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the text communication) and transforms the input data through various stages of the data flow into new types of data files (e.g., identification of the query into a category) Moreover, these new data files are transformed further into a response to the query relating to a roadside assistance request and sent to the user device 104 to provide an answer to the query regarding the roadside service request to the user, which enables the computing device 302 to do something it could not do before-generate a response to a query relating to a roadside assistance request using a chatbot.

Additionally, the systems and operations disclosed herein represent an improvement to the technical field of machine learning processing. For instance, the chatbot computing platform 106 can generate response to a query regarding a roadside assistance request without the need for human intervention in processing the response. Moreover, data can be leveraged from different data sources with varying levels of abstraction to provide a highly customized response. These techniques are rooted in technology and could not have existed prior to the advent of natural language processing and/or machine learning analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the chatbot computing platform 106, and/or other software, modules, services, and operations discussed herein may be embodied by instructions stored on the memory devices 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

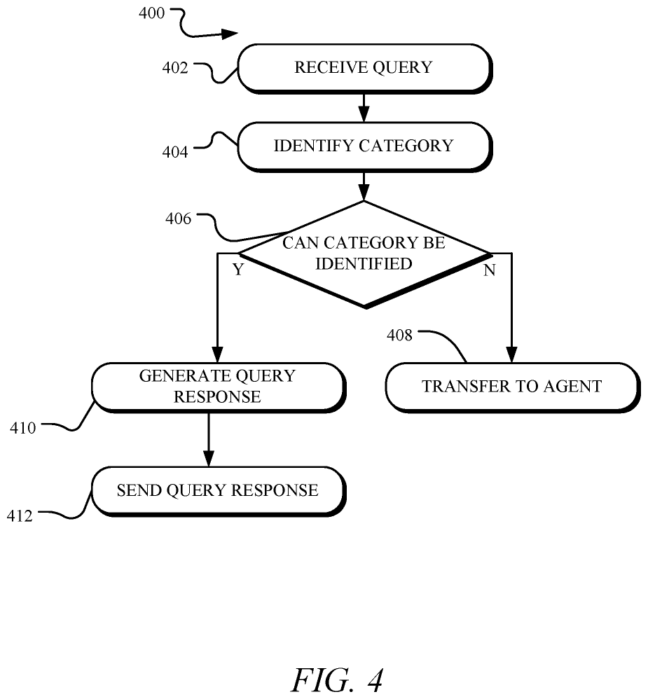

FIG. 4 depicts an example method 400 to generate a response to a query relating to a roadside assistance request, which can be performed by any of the systems 100-300 discussed herein. The method 400 can, in some instances, occur in real time.

At operation 402, the method 400 can receive a query via a user device 104. The query is associated with a previously submitted roadside assistance request and is a text communication inputted by a user into an interface of the user device 104. In an implementation, the query can be related to a status update of the roadside assistance request. In this instance, the query may state, “what is the ETA.” In another implementation, the query can be related to cancelling the roadside assistance request. In this instance, the query may state, “cancel.” In another implantation, the query can be related to information for a service provider (e.g., instructions to access the vehicle, vehicle details, such as, year, model, make, and/or color of the vehicle). In this instance, the query may state, “my gate code is 1234,” “my car is a silver SUV,” etc.

At operation 404, the method 400 can identify a category of the query. The categories can include a status update of the roadside assistance request, cancellation of the roadside assistance request, and information for the service provider.

At operation 406, if the method 400 cannot identify the category, the method 400 proceeds to operation 408. If the method 400 can identify the category, the method 400 proceeds to operation 410.

At operation 408, the method 400 transfers the text communication to a live agent. The live agent can then directly communicate with the user via the user device 104 using text or voice communication.

At operation 410, the method 400 can generate a response to the query. In an implementation where the category is related to the status update of the roadside assistance request, the benefit provider system 102 can retrieve the status (e.g., estimated time of arrival, phone number of the technician, etc.) from the roadside service provider system 108 and/or a technician device. In this implementation, the method 400 generates a response based on the retrieved information. For instance, the response can state, “the technician will arrive in approximately 15 minutes.” In an implementation where the category is related to the cancellation of the roadside assistance request, the benefit provider system 102 can generate and communicate a cancellation request to the roadside service provider system 108 and/or a technician device. In this implementation, the method 400 generates a response to confirm the cancellation. For instance, the response can state, “the service request has been successfully cancelled.” In an implementation where the category is related to information for the service provider, the benefit provider system 102 can generate and communicate the information to the roadside service provider system 108 and/or a technician device. In this implementation, the method 400 generates a response to confirm the information has been sent to the service provider. For instance, the response can state, “the information has been successfully sent.” At operation 412, the method 400 can send the response to the user device 104 for display on the user device 104.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A computer implemented method comprising:
receiving a query in a text communication from a user device, the query associated with a previously submitted roadside assistance request;
identifying a category of the query;
generating a query response based on the category; and
sending the query response to the user device to cause the user device to display the query response.

2. The method of claim 1, wherein the text communication is received via one of a text message or an online chat interface.

3. The method of claim 1, wherein the user device is a computing device.

4. The method of claim 1, wherein if the category cannot be identified, the method further comprising:
transferring the text communication to a live agent.

5. The method of claim 1, wherein the category is related to a status update of the previously submitted roadside assistance request.

6. The method of claim 5, wherein the query response is based on information retrieved relating to the status update.

7. The method of claim 1, wherein the category is related to a cancellation of the previously submitted roadside assistance request.

8. The method of claim 1, wherein the category is related to information for a service provider.

9. A system comprising:
a chatbot computing platform comprising one or more processors configured to:
receive a query in a text communication from a user device, the query associated with a roadside assistance request;
identify a category of the query;
generate a response based on the category; and
send the response to the user device to cause the user device to display the response.

10. The system of claim 9, wherein if the category cannot be identified, the one or more processors is further configured to:
transfer the text communication to a live agent.

11. The system of claim 9, wherein the text communication is received via one of a text message or an online chat interface.

12. The system of claim 9, wherein the category is related to a status update of the roadside assistance request.

13. The system of claim 12, wherein the response is based on information retrieved relating to the status update.

14. The system of claim 9, wherein the category is related to a cancellation of the roadside assistance request.

15. The system of claim 9, wherein the category is related to information for a service provider responding to the roadside assistance request.

16. The system of claim 9, wherein the user device is a mobile computing device.

17. One or more tangible non-transitory computer-readable storage media storing computer-executable instructions for performing a computer process on a computing system, the computer process comprising:
receiving a query in a text communication from a user device, the query associated with a roadside assistance request;
identifying a category of the query;
generating a response based on the category; and
sending the response to the user device to cause the user device to display the response.

18. The one or more tangible non-transitory computer-readable storage media storing computer-executable instructions for performing the computer process on the computing system of claim 17, wherein the text communication is received via one of a text message or an online chat interface.

19. The one or more tangible non-transitory computer-readable storage media storing computer-executable instructions for performing the computer process on the computing system of claim 17, wherein the category is related to one of a status update of the roadside assistance request, a cancellation of the roadside assistance request, or information for a service provider.

20. The one or more tangible non-transitory computer-readable storage media storing computer-executable instructions for performing the computer process on the computing system of claim 17, wherein if the category cannot be identified, the computer process further comprises:
transferring the text communication to a live agent.
